(19) United States
(12) Patent Application Publication
(10) Pub. No.: US 2009/0122549 A1
(43) Pub. Date: May 14, 2009

(54) Lighting Device and Operating Method Thereof

(75) Inventor: Sheng-Fa Hou, Taipei City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: LITE-ON IT CORPORATION, Taipei City (TW)

(21) Appl. No.: 12/184,345

(22) Filed: Aug. 1, 2008

(30) Foreign Application Priority Data
Nov. 8, 2007 (CN) 200710169286.6

(51) Int. Cl. F21V 17/02; G02B 5/06

(52) U.S. Cl. 362/282; 359/837

(57) ABSTRACT

A lighting device includes a first platform, a light-emitting unit, a second platform and a connecting member. The light-emitting unit is disposed on the first platform for emitting light beams. The second platform is made of transparent material and has a chamber therein. The chamber contains immiscible first and second fluids with different refractive indices. The connecting member is used for interconnecting the first platform and the second platform and transmitting inclination of the second platform. The light beams are refracted by the first and second fluids when the second platform is inclined at a specified inclining angle.

### FIELD OF THE INVENTION

The present invention relates to a lighting device, and more particularly to a lighting device comprising a transparent platform containing immiscible first and second fluids with different refractive indices for adjusting the orientation and inclination of incident light. The present invention relates to a method of operating such a lighting device.

### BACKGROUND OF THE INVENTION

Lighting devices such as lamps or bulbs are designed to produce light from electricity. With rapid development of industrial techniques, these lighting devices become essential components in our daily lives because they can improve the living quality. In the early stage, lighting devices are used for simply providing a bright place. With diversified living attitudes, in addition to the illuminating purpose, proper lighting devices can enhance task performance or aesthetics. For complying with various demands, the lighting devices should be designed to have desired sizes or produce light with desired illumination zone, orientation, inclination or intensity.

For example, especially for the large-scale stage designs or small-scale cabin illumination systems, it is very important to adjust the orientation and inclination of incident light. Conventionally, there are three types of mechanisms for adjusting the orientation and inclination of incident light. These three mechanisms are designed according to the configurations, light sources or light path switching structures.

FIG. 1 is a schematic diagram illustrating a first type lighting device for adjusting the orientation and inclination of incident light. Such a lighting device is disclosed in for example U.S. Pat. No. 5,690,417, and the contents of which are hereby incorporated by reference. As shown in FIG. 1, the lighting device 10 principally comprises a light source group 11. The light source group 11 comprises a plurality of lamps. These lamps can be inclined at different angles so as to adjust the orientation and inclination of incident light. As a consequence, the light beams emitted by the lamps can be selectively directed to a workpiece 13 on a work table 12. This lighting device, however, still has some drawbacks. For example, a great amount of light sources are required in this lighting device 10. In addition, the control system for this lighting device 10 is very complicated. In a case that the lamps are selectively turned on and turned off while changing orientation and inclination of incident light, discontinuous illumination will possibly occur.

FIG. 2 is a schematic diagram illustrating a second type lighting device for adjusting the orientation and inclination of incident light. Such a lighting device is disclosed in for example U.S. Pat. Nos. 4,118,109, 6,344,937 and 7,217,002, and the contents of which are hereby incorporated by reference. The lighting device 20 principally comprises a light source 21, two refractive elements 22 and 23 of specified shapes, and optionally other lenses with different refractive indices (not shown). The refractive elements 22 and 23 are for example prisms. By appropriately rotating one or both of the refractive elements 22 and 23, the beam path 24 of the light source 21 is changed such that the light cone emerging from the light source 21 or the light cone surface generated by the same on a projection surface can be moved over an area enclosed by line 25. Since the lighting device 20 should have a receptacle for accommodating the refractive elements 22 and 23 and the driving element (not shown), the overall volume of the lighting device is very huge and the fabricating cost thereof is increased.

FIG. 3 is a schematic diagram illustrating a third type lighting device for adjusting the orientation and inclination of incident light. Such a lighting device is disclosed in for example U.S. Pat. Nos. 3,912,918, 5,070,434 and 6,461,024, and the contents of which are hereby incorporated by reference. For reducing the overall volume and saving the fabricating cost, the orientation and inclination of incident light for the lighting device 30 are manually controlled. A light source is mounted inside a casing 31 and a cone member 32. The casing 31 may be fixed or supported by a specified apparatus. A shaft 34 is secured to a ball assembly 33. By rotating the ball assembly 33, the cone member 32 is adjusted to a desired irradation position as shown in dotted line such that orientation and inclination of incident light are adjustable. This lighting device 30 is applicable to cabin illumination systems or other small-scale illumination systems. The manual operation of such a lighting device is not convenient. In addition, it is labor-intensive to rotate the cone member and the ball assembly.

Therefore, there is a need of providing an improved lighting device and a method of operating such a lighting device to obviate the drawbacks encountered from the prior art.

### SUMMARY OF THE INVENTION

The present invention provides a lighting device having a simplified mechanism for adjusting the orientation and inclination of incident light. The lighting device of the present invention can provide continuous illumination, direct the light beams to a desired irradation position and result in a desired illumination zone according to the user's requirement.

In accordance with an aspect of the present invention, there is provided a lighting device. The lighting device includes a first platform, a light-emitting unit, a second platform and a connecting member. The light-emitting unit is disposed on the first platform for emitting light beams. The second platform is made of transparent material and has a chamber therein. The chamber contains immiscible first and second fluids with different refractive indices. The connecting member is used for interconnecting the first platform and the second platform and transmitting inclination of the second platform. The light beams are refracted by the first and second fluids when the second platform is inclined at a specified inclining angle.

In accordance with another aspect of the present invention, there is provided a method of operating a lighting device. The lighting device includes a first platform, a light-emitting unit disposed on the first platform, a second platform made of transparent material and having a chamber therein, and a connecting member for interconnecting the first platform and the second platform. The chamber contains immiscible first and second fluids with different refractive indices. The method includes steps of: turning on the light-emitting unit to emit light beams; and controlling the connecting member to drive inclination of the second platform at different inclining angles such that the light beams are refracted by the first and second fluids and directed to a desired irradation position at a specified refracting angle.

In accordance with another aspect of the present invention, there is provided a transparent platform for use with a light-emitting unit of a lighting device. The transparent platform includes a chamber and immiscible first and second fluids. The first and second fluids are contained in the chamber and have different refractive indices. The light beams emitted by the light-emitting unit are refracted by the first and second fluids when the second platform is inclined at a specified inclining angle.

### BRIEF DESCRIPTION OF THE DRAWINGS

The above contents of the present invention will become more readily apparent to those ordinarily skilled in the art after reviewing the following detailed description and accompanying drawings, in which:

FIG. 1 is a schematic diagram illustrating a first type lighting device for adjusting the orientation and inclination of incident light according to the prior art;

FIG. 2 is a schematic diagram illustrating a second type lighting device for adjusting the orientation and inclination of incident light according to the prior art;

FIG. 3 is a schematic diagram illustrating a third type lighting device for adjusting the orientation and inclination of incident light according to the prior art;

FIG. 4A is a schematic perspective view of a lighting device according to a preferred embodiment of the present invention;

FIG. 4B is a schematic perspective view of the lighting device of FIG. 4A taken from another viewpoint;

FIG. 4C is a schematic cross-sectional view illustrating the two-layered immiscible fluid system in the second platform of FIG. 4A;

FIGS. 5A, 5B and 5C are schematic diagrams illustrating three examples of adjusting orientations of the resultant illumination by inclining the second platform at different angles according to a first embodiment of the present invention;

FIGS. 6A, 6B and 6C are schematic diagrams illustrating three examples of adjusting orientations of the resultant illumination by inclining the second platform at different angles according to a second embodiment of the present invention; and

FIG. 7 is a schematic cross-sectional view illustrating another second platform used in the lighting device of the present invention.

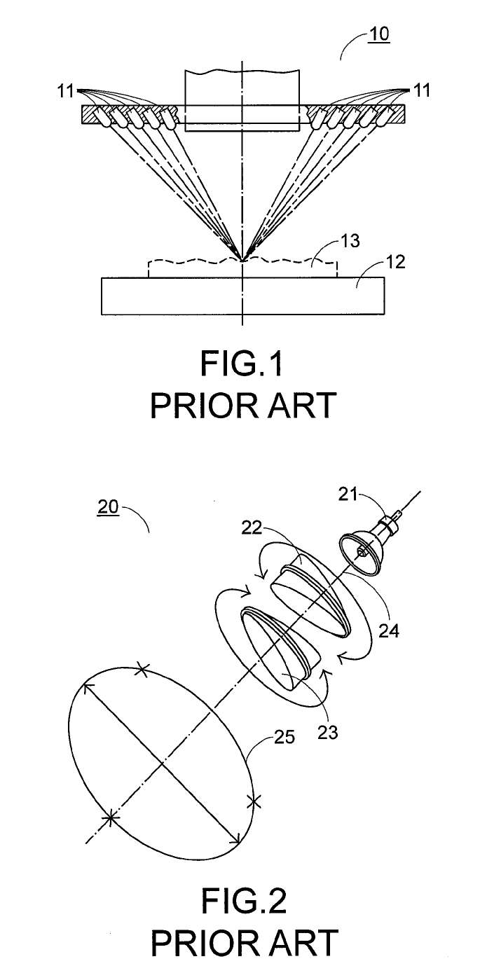

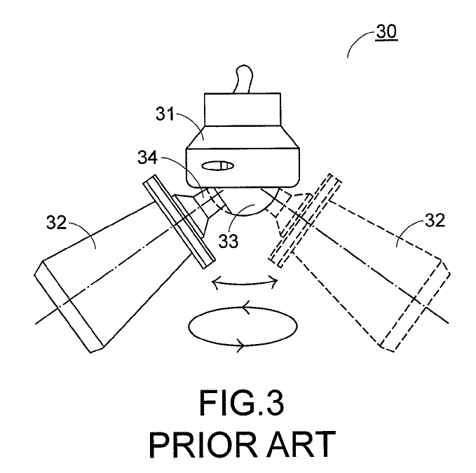

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

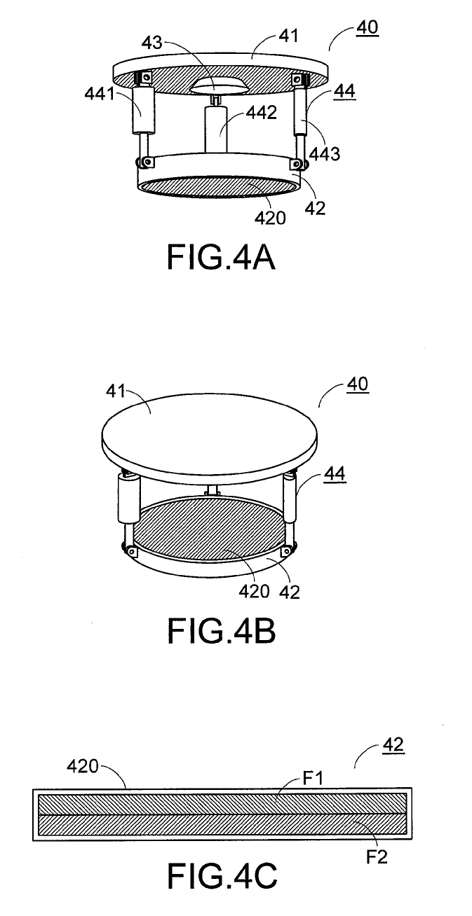

FIG. 4A is a schematic perspective view of a lighting device according to a preferred embodiment of the present invention. FIG. 4B is a schematic perspective view of the lighting device of FIG. 4A taken from another viewpoint. As shown in the drawings, the lighting device 40 comprises a first platform 41, a second platform 42, a light-emitting unit 43 and a connecting member 44. The first platform 41 and the second platform 42 are combined together through the connecting member 44. The light-emitting unit 43 is mounted on the first platform 41 for producing light. The control circuits of the light-emitting unit 43 and associated power supplying circuits are mounted within the first platform 41.

The first platform 41 of the lighting device 40 may be fixed or supported on a specified surface (not shown) so that the first platform 41 is immobile. Whereas, the second platform 42 is inclined with respect to the first platform 41 at various inclining angles by adjusting the connecting member 44. The connecting member 44 is substantially a retractable rod assembly composed of three retractable rods 441, 442 and 443. Each of the three retractable rods 441, 442 and 443 has an end coupled to the first platform 41 and the other end coupled to the second platform 42. In accordance with a key feature of the present invention, both ends of the retractable rods 441, 442 and 443 of the connecting member 44 are pivotally coupled to the first platform 41 and the second platform 42, respectively. In addition, the retractable rods 441, 442 and 443 can be expanded and contracted. In an embodiment, each of the retractable rods 441, 442 and 443 includes a larger-diameter tube and a smaller-diameter post, wherein the smaller-diameter post may be partially or completely sheathed by the larger-diameter tube. By changing the overlapping region between the larger-diameter tube and the smaller-diameter post, the overall length for each of the retractable rods 441, 442 and 443 is adjustable.

Please refer to FIG. 4A and FIG. 4B again. The lighting device 40 further comprises at least one driving element (not shown). An exemplary driving element includes a linear motor. The driving element is connected to the connecting member 44 for driving movement of the connecting member 44 and thus transmitting the second platform 42 to be inclined with respect to the first platform 41. It is preferred that the lighting device 40 comprises three driving elements and these driving elements are respectively connected to the retractable rods 441, 442 and 443 so as to control adjust the overall lengths for the retractable rods 441, 442 and 443. Since the overall lengths for the retractable rods 441, 442 and 443 are adjustable and both ends of the retractable rods 441, 442 and 443 are pivotally coupled to the first platform 41 and the second platform 42, the second platform 42 can be inclined with respect to the first platform 41 at various angles in the three-dimensional space.

In the above embodiment, the lighting device 40 has three retractable rods for facilitating firmly fixing the second platform 42. For tuning the inclining angle of the second platform 42 with respect to the first platform 41, the number of retractable rods is preferably more than three. It is noted that, however, those skilled in the art will readily observe that numerous modifications and alterations may be made while retaining the teachings of the invention. For example, the connecting member is not restricted to the above retractable rod assembly as long as the connecting member may be used to transmit the second platform to be inclined with respect to the first platform at various angles in the three-dimensional space. In some embodiments, the retractable rods of the connecting member includes are substantially flexible tubes, which may be expanded or contracted by either a manual driving manner or a mechanical driving manner. By adjusting the expanding or contracting degrees of these flexible tubes, the second platform is inclined and the fluids within the second platform are deformed and acted as a prism. Such a prism can diffract the light beams emitted by the light-emitting unit.

Likewise, the control circuits of the driving element and associated power supplying circuits are mounted within the first platform 41. Alternatively, these circuits may be mounted within the retractable rods 441, 442 and 443. In the above embodiments, three driving elements are disposed within respective retractable rods. Alternatively, one or two driving elements may be disposed within respective retractable rods or the first platform 41 and all retractable rods are driven by the driving elements to expand and contract via transmission mechanism (e.g. gears).

In accordance with another feature of the present invention, the upper surface and the lower surface of the second platform 42 are made of transparent material. A chamber 420 is defined within the second platform 42 for accommodating a first fluid F1 and a second fluid F2. The first fluid F1 and the second fluid F2 are light-penetrable. In addition, the first fluid F1 and the second fluid F2 are immiscible and have different densities so as to form a two-layered immiscible fluid system. A schematic cross-sectional view of the two-layered immiscible fluid system in the chamber 420 is illustrated in FIG. 4C.

Please refer to FIG. 4C again. In this embodiment, the first fluid F1 and the second fluid F2 have equal capacity and the chamber 420 is filled with the first fluid F1 and the second fluid F2. In other words, each of the first fluid F1 and the second fluid F2 occupies a half volume of the chamber 420. Moreover, the first fluid F1 and the second fluid F2 have different refractive indices. For example, the first fluid F1 is air (refractive index=1) and the second fluid F2 is a liquid (refractive index=1.61).

Since the upper surface and the lower surface of the second platform 42 are transparent and the first fluid F1 and the second fluid F2 are light-penetrable, the light beams emitted by the light-emitting unit 43 can pass through the second platform 42. By changing the inclining angle of the second platform 42 with respect to the first platform 41, the angle of the light beam incident into the second platform 42 is varied. Since the first fluid F1 and the second fluid F2 have different refractive indices, the light beams emitted by the light-emitting unit 43 are refracted by the two-layered immiscible fluid system to result in varied orientations of the resultant illumination.

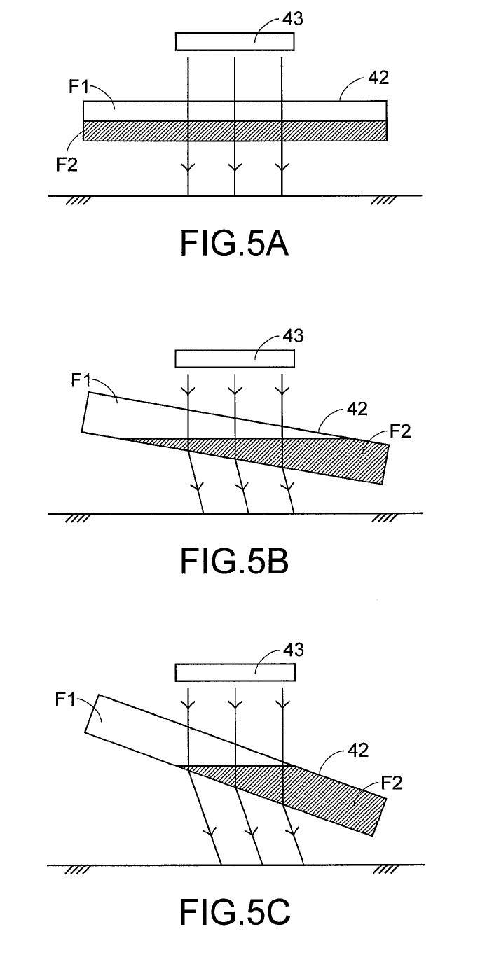

FIGS. 5A, 5B and 5C are schematic diagrams illustrating three examples of adjusting orientations of the resultant illumination by inclining the second platform at different angles according to a first embodiment of the present invention. In FIG. 5A, the inclining angle of the second platform 42 is zero degree. The light beams emitted by the light-emitting unit 43 will perpendicularly pass through the second platform 42 and not refracted by the two-layered immiscible fluid system of the first fluid F1 and the second fluid F2. That is, the light beams emitted by the light-emitting unit 43 are directed to the region under the light-emitting unit 43. For adjusting orientation and inclination of the light beams emitted by the light-emitting unit 43, the relative lengths of the retractable rods 441, 442 and 443 should be changed such that the second platform 42 is inclined with respect to the first platform 41 at various angles in the three-dimensional space. For clarification, the second platform 42 inclined in a two-dimensional plane will be illustrated in FIGS. 5B and 5C. In addition, the thickness of the second platform 42 is ignored in these drawings. The inclining angle of the second platform 42 is 15 degree in FIG. 5B and 30 degree in FIG. 5C. In this embodiment, since the first fluid F1 is air, the incident light beams are not diffracted by the first fluid F1. The second fluid F2 is a liquid with a refractive index of 1.61 so that the incident light beams are diffracted by the second fluid F2. As a result, the light beams emitted by the light-emitting unit 43 are refracted by the two-layered immiscible fluid system to result in varied orientations of the resultant illumination. That is, the light beams emitted by the light-emitting unit 43 are directed to a desired irradation position or a desired illumination zone by changing the inclining angle of the second platform 42. Moreover, as the inclining angle of the second platform 42 is increased, the refracting effect and thus the emergence angle are both increased.

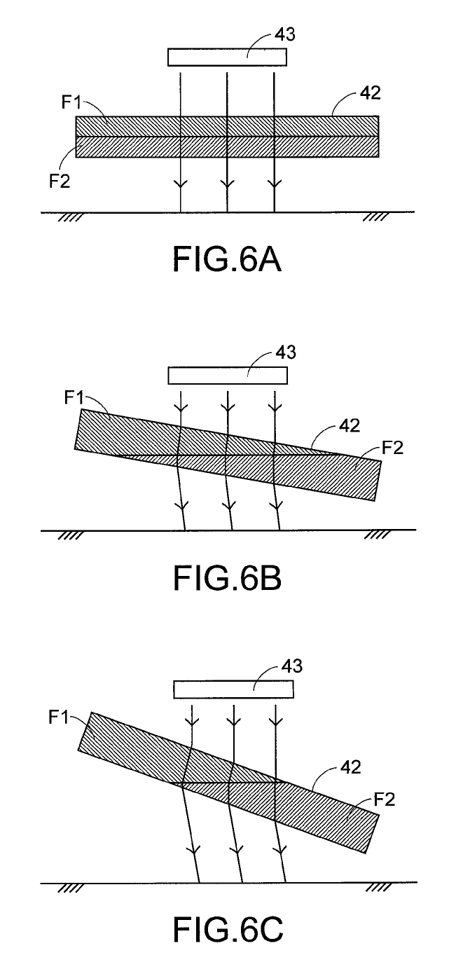

FIGS. 6A, 6B and 6C are schematic diagrams illustrating three examples of adjusting orientations of the resultant illumination by inclining the second platform at different angles according to a further embodiment of the present invention. In this embodiment, the first fluid F1 is a first liquid with a refractive index of 1.33 and the second fluid F2 is a second fluid with a refractive index of 1.61. In FIG. 6A, the inclining angle of the second platform 42 is zero degree. The light beams emitted by the light-emitting unit 43 will perpendicularly pass through the second platform 42 and not refracted by the two-layered immiscible fluid system of the first fluid F1 and the second fluid F2. For adjusting orientations of the resultant illumination of the light beams emitted by the light-emitting unit 43, the second platform 42 should be inclined with respect to the first platform 41. In this embodiment, the thickness of the second platform 42 is ignored in these drawings. The inclining angle of the second platform 42 is 15 degree in FIG. 6B and 30 degree in FIG. 6C. Since the refractive indices of the first fluid F1 and the second fluid F2 are both greater than that of the air, the incident light beams are diffracted by the first fluid F1 and the second fluid F2. As a result, the light beams emitted by the light-emitting unit 43 are refracted by the two-layered immiscible fluid system to result in varied orientations of the resultant illumination. That is, the light beams emitted by the light-emitting unit 43 are directed to a desired irradation position or a desired illumination zone by changing the inclining angle of the second platform 42. Moreover, as the inclining angle of the second platform 42 is increased, the refracting angle is increased.

Since the two-layered immiscible fluid system of FIG. 6 has different refractive indices from that of FIG. 5, the resultant illumination zones of these two lighting devices are different. Accordingly, an optimal orientation or illumination zone is obtainable by elaborately selecting the fluids F1 and F2 while taking the thickness of the second platform into consideration. In the above embodiments, after the light-emitting unit 43 is activated to emit light beams, the connecting member 44 is controlled to adjust the inclining angle of the second platform 42. As the second platform 42 is inclined, the fluids F1 and F2 are deformed and acted as a prism. Such a prism can diffract the light beams emitted by the light-emitting unit 43. Accordingly, the light beams emitted by the light-emitting unit 43 are directed to a desired irradation position or a desired illumination zone by changing the inclining angle of the second platform 42.

The lighting device 40 may further comprise a control interface (not shown). An example of the control interface includes and is not limited to a remote controller or a user operation interface for controlling on/off status or other functions. By the remote controller or the user operation interface, the connecting member 44 is controlled to adjust the inclining angle of the second platform 42.

The lighting device 40 of the present invention is applicable to any occasions such as the large-scale stage designs, small-scale cabin illumination systems or indoor lighting systems. The overall volume of the lighting device 40 may be changed according to the desired illumination zone. An example of the light-emitting unit 43 includes but is not limited to a light emitting diode (LED), an incandescent bulb or a fluorescent lamp. In a case that the lighting device 40 is applied to a small-scale occasion, the inclining angle of the second platform may be manually adjusted. Since the applications of the lighting device may be custom-made, the lighting device of the present invention is diversified and cost-effective.

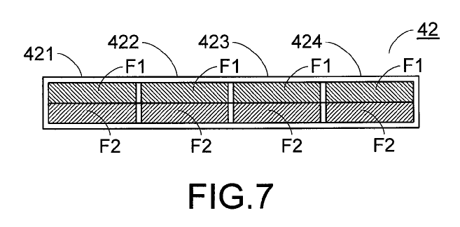

The above embodiments are illustrated by referring to the second platform 42 having a chamber 420. Nevertheless, the second platform 42 may have a plurality of chambers. FIG. 7 is a schematic cross-sectional view illustrating another second platform used in the lighting device of the present invention. The second platform 42 comprises four chambers 421, 422, 423 and 424. Each of the chambers 421, 422, 423 and 424 contain a first fluid F1 and a second fluid F2 in equal capacity. The first fluid F1 and the second fluid F2 are light-penetrable and immiscible and have different densities so as to form a two-layered immiscible fluid system. As preciously described in FIGS. 5 and 6, the area of the interface between the first fluid F1 and the second fluid F2 is reduced as the inclining angle of the second platform 42 is increased. In a case that the area of the light cone emerging from the light-emitting unit is relatively large, the second platform with several chambers (as shown in FIG. 7) is more feasible to diffract the light beams. Moreover, if a high inclining angle of the second platform is required, the second platform of FIG. 7 is suitable and the brightness of the diffracted light beams is still sufficient.

From the above description, the lighting device of the present invention is capable of adjusting the orientation and inclination of incident light by inclining the second platform. Since the light-emitting unit is immobile during the process of adjusting the orientation and inclination, the lighting device of the present invention is very simple and succinct in structure. The lighting device of the present invention is applicable to any occasions such as the large-scale stage designs, small-scale cabin illumination systems or indoor lighting systems. According to the use's demands, the lighting device of the present invention may be manually or remotely controlled; the refractive indices of the first and second fluids may be elaborately selected; and the second platform may include one or more chambers for accommodating the two-layered immiscible fluid system. Moreover, the light beams are continuously emitted by the light-emitting unit without being influenced by inclination of the second platform. Due to the continuous illumination, the light beams diffracted by the two-layered immiscible fluid system are not discomfort to the user.

While the invention has been described in terms of what is presently considered to be the most practical and preferred embodiments, it is to be understood that the invention needs not to be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A lighting device comprising:
a first platform;
a light-emitting unit disposed on the first platform for emitting light beams;
a second platform made of transparent material and having a chamber therein, wherein the chamber contains immiscible first and second fluids with different refractive indices; and
a connecting member for interconnecting the first platform and the second platform and transmitting inclination of the second platform, wherein the light beams are refracted by the first and second fluids when the second platform is inclined at a specified inclining angle.

2. The lighting device according to claim 1 wherein the control circuits of the light-emitting unit and associated power supplying circuits are mounted within the first platform.

3. The lighting device according to claim 1 further comprising at least one driving element, which is connected to the connecting member, for driving the connecting member to transmit inclination of the second platform.

4. The lighting device according to claim 1 wherein the connecting member is substantially a retractable rod assembly composed of at least three retractable rods, each of the retractable rods has an end pivotally coupled to the first platform and the other end pivotally coupled to the second platform.

5. The lighting device according to claim 4 wherein both ends of each retractable rod are pivotal such that the overall length of each retractable rod is adjustable.

6. The lighting device according to claim 4 further comprising at least one driving element, which is connected to the retractable rods, for driving the retractable rods to transmit inclination of the second platform.

7. The lighting device according to claim 6 further comprising a control interface, wherein the driving unit is controlled via the control interface to drive inclination of the second platform such that the light beams emitted by the light-emitting unit are directed to a desired irradation position or result in a desired illumination zone.

8. The lighting device according to claim 1 wherein the first and second fluids are deformed and acted as a prism when the second platform is inclined, so that the light beams emitted by the light-emitting unit are diffracted by the prism.

9. The lighting device according to claim 1 wherein the first and second fluids are light-penetrable, and have different densities so as to cooperatively form as a two-layered immiscible fluid system.

10. A method of operating a lighting device, the lighting device comprising a first platform, a light-emitting unit disposed on the first platform, a second platform made of transparent material and having a chamber therein, and a connecting member for interconnecting the first platform and the second platform, the chamber containing immiscible first and second fluids with different refractive indices, the method comprising steps of:
turning on the light-emitting unit to emit light beams; and
controlling the connecting member to drive inclination of the second platform at a specified inclining angle such that the light beams are refracted by the first and second fluids and directed to a desired irradation position at a specified refracting angle.

11. The method according to claim 10 wherein the lighting device further comprises at least one driving element, which is connected to the connecting member, for driving the connecting member to transmit inclination of the second platform.

12. The method according to claim 10 wherein the lighting device further comprises a control interface, wherein the driving unit is controlled via the control interface to drive inclination of the second platform such that the light beams are refracted by the first and second fluids and directed to the desired irradation position at the specified refracting angle.

13. A transparent platform for use with a light-emitting unit of a lighting device, the transparent platform comprising:
a chamber; and
immiscible first and second fluids, which are contained in the chamber and have different refractive indices, wherein the light beams emitted by the light-emitting unit are refracted by the first and second fluids when the second platform is inclined at a specified inclining angle.

14. The transparent platform according to claim 13 wherein the lighting device further comprises an additional platform and a connecting member, and the control circuits of the light-emitting unit and associated power supplying circuits are mounted within the additional platform.

15. The transparent platform according to claim 14 wherein the transparent platform is connected to the additional platform through the connecting member.

16. The transparent platform according to claim 13 wherein the connecting member is substantially a retractable rod assembly composed of at least three retractable rods, each of the retractable rods has an end pivotally coupled to the additional platform and the other end pivotally coupled to the transparent platform.

17. The transparent platform according to claim 16 wherein both ends of each retractable rod are pivotal such that the overall length of each retractable rod is adjustable.
